(19) United States
(12) Patent Application Publication
(10) Pub. No.: US 2007/0177866 A1
(43) Pub. Date: Aug. 2, 2007

(54) Camera extension arm

(76) Inventor: Yoshizo Fujimoto, Kiryu City (JP)

Correspondence Address: DERGOSITS & NOAH LLP, FOUR EMBARCADERO CENTER, SUITE 1450, SAN FRANCISCO, CA, 94111, US

(21) Appl. No.: 11/345,555

(22) Filed: Jan. 31, 2006

(51) Int. Cl. G03B 13/02

(52) U.S. Cl. 396/376

(57) ABSTRACT

A device for facilitating the taking of photographic self portraits. The device includes a handle sized to be held by a single hand of a user. The device further includes an extension arm appended at its proximal end to the handle and at its distal end to a camera holder. The extension arm is configured to position a camera secured to the camera holder sufficiently above the handle to eliminate the handle from the field of a picture taken when using the present device. The device also includes a camera and a mirror secured to the camera holder, the mirror being sized and positioned with respect to the camera to enable a user to preview an image to be captured by the camera in creating a photographic self portrait.

### TECHNICAL FIELD

The present invention involves a device for facilitating the taking of a photographic self portrait. This device enables a user to preview the image to be captured by a camera and to decide when and if the shutter is to be tripped to consummate the picture-taking operation.

### BACKGROUND OF THE INVENTION

It has always been somewhat problematic for an individual or group of individuals to capture a self portrait employing a camera. Generally, one member of a group is eliminated from a photograph as the picture taker. If all individuals of a group wish to be photographed jointly, the camera must be properly positioned and a timer set providing sufficient latitude to enable all members of the group to station themselves in front of the camera. However, when doing so, no one is stationed behind the camera viewfinder and, as a result, images taken aren't always framed or positioned as one would like. Further, self timers tend to operate somewhat unreliably and, as a consequence, those standing before a self timed camera oftentimes must maintain their positioning and facial expressions for an undetermined amount of time and until the camera shutter trips. This again is quite difficult and oftentimes results in a portrait that is less than ideal.

It is thus an object of the present invention to provide a camera and supporting device capable of being directly controlled by a user.

It is yet a further object of the present invention to provide a camera and supporting device that can be triggered by a user upon a user's preview of the image to be captured by the camera lens.

It is still a further object of the present invention to provide a camera and supporting device having an attraction feature which can create an element of surprise or distraction in order to enhance the image to be captured by the camera.

These and further objects will be more readily appreciated when considering the following disclosure and appended drawings.

### SUMMARY OF THE INVENTION

The present invention is directed to a device for facilitating the taking of photographic self portraits. The device comprises a handle sized to be held by a single hand of a user, an extension arm appended at its proximal end to said handle and at its distal end to a camera holder, said extension arm configured to position a camera secured to said camera holder sufficiently above said handle to eliminate said handle from a picture taken when using the present device in taking a photographic self portrait. The device also includes a camera and a mirror secured to said camera holder, said mirror sized and positioned with respect to said camera to enable a user to preview an image to be captured by said camera in creating said photographic self portrait.

### BRIEF DESCRIPTION OF THE FIGURES

FIG. 1 is a prospective view of the present invention including an extension arm, handle, camera and mirror combined to enable the present invention to function for its proposed purpose.

FIGS. 2-1, 2-2, 2-3 and 2-4 are various bottom, side and back plan views of the camera holder illustrating the detail of the holder mechanism as it supports a suitable camera and mirror.

FIG. 3 is a partially exploded perspective view of the present invention showing additional detail of its construction.

FIG. 4 is a side cut away view taken along A-A of FIG. 3.

FIGS. 5, 6, and 7 are perspective views of alternative embodiments of the present invention showing a suitable camera and mirror combination held on an extension arm and further providing attraction means for attracting the attention of a user.

FIG. 8 is a perspective view of the present invention showing a suitable camera held on an extension arm further providing attraction means for attracting the attention of a user.

FIG. 9 is a back view of the present invention showing additional detail of its construction.

FIGS. 10, 11, and 12 are a perspective views of the present invention showing a suitable camera held on an extension arm further providing attraction means for attracting the attention of a user.

FIG. 13 is a back view of the present invention showing additional detail of its construction.

FIG. 14 is a perspective view of the present invention showing a suitable camera and mirror combination held on an extension arm further supported by a tripod.

FIGS. 15, 15-A, 15-B, 15-C, and 15-D are various front, top, side and back views of the camera holder illustrating the detail of the holder mechanism as it supports a suitable camera and mirror.

FIG. 16 is a perspective view of the present invention showing a suitable camera and mirror combination held on an extension arm.

FIG. 17 is a perspective view of the present invention showing a shutter and pump trigger mechanism enabling the present invention to perform its proposed purpose.

### DETAILED DESCRIPTION OF THE INVENTION

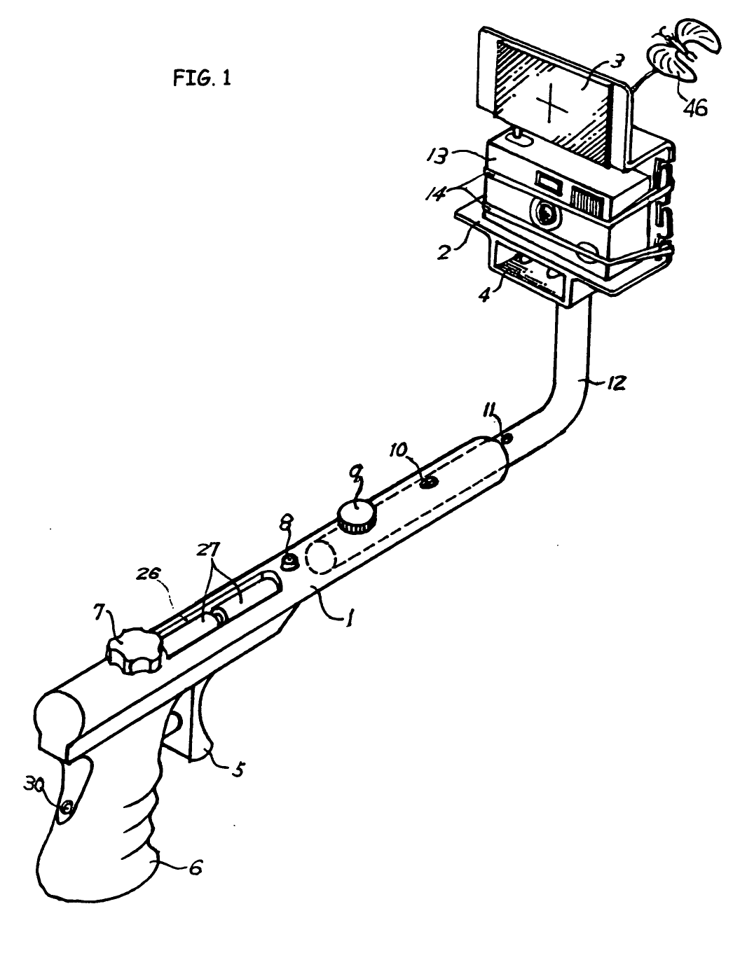

Turning first to FIG. 1, the present device including extension arm 1 and handle 6 are provided. Extension arm 1 includes extension arm elbow 12 for vertically positioned camera 13 so that a user, when gripping handle 6 in the form of, preferably, a pistol grip, is able to take a self portrait without extension arm 1 or handle 6 appearing in the photograph.

At the proximal end of extension arm 1 is provided handle or grip 6 and at its distal end is provided camera holder 2 employed to support camera 13 and mirror 3.

To enhance the flexibility and usefulness of the present invention, extension arm 1 is fitted with locking pinhole 10 and locking pin 9 which in combination with locking pinhole 11 in the extension arm elbow allows for adjustment of the horizontal distance between handle 6 and camera 13. This will enable one to adjust the field size of the image being captured by camera 13 in going from a single user self portrait to a group self portrait embodiment.

Camera 13 can be maintained upon camera holder 2 by any appropriate means. In order to enhance the sense of simplicity of the present invention, elastic bands 14 are shown strapped about the body of camera 13. In another embodiment, camera 13 can be encased between camera holder 2 and camera top holder 65. In addition, camera holder 2 can be provided with a light housing 4 to provide illumination picked up by the lens of camera 13.

As previously noted, mirror 3 is provided generally having a slightly downward inclination for viewing by a user. It is an object of the present invention to provide a mirror having the ability to replicate the image being captured by camera 13 through the camera lens to enable a user to preview the image being captured by the camera. Mirror cross hairs 34 are configured within mirror 3 in order to appropriately inform a user of the image center to further enhance the appropriate field capture by camera 13. In another embodiment, mirror 3 is coupled to under rib 68 of holder 2 by way of mirror hinge 70. Mirror hole 33 within mirror 3 provides a clear line of vision for lens 50 when mirror 3 is folded before camera 13.

Oftentimes, a photographic image can be enhanced if the subject of the image is startled or somehow preoccupied. Such an embodiment helps to prevent a photographic image as appearing to be staged or overly stilted in composition.

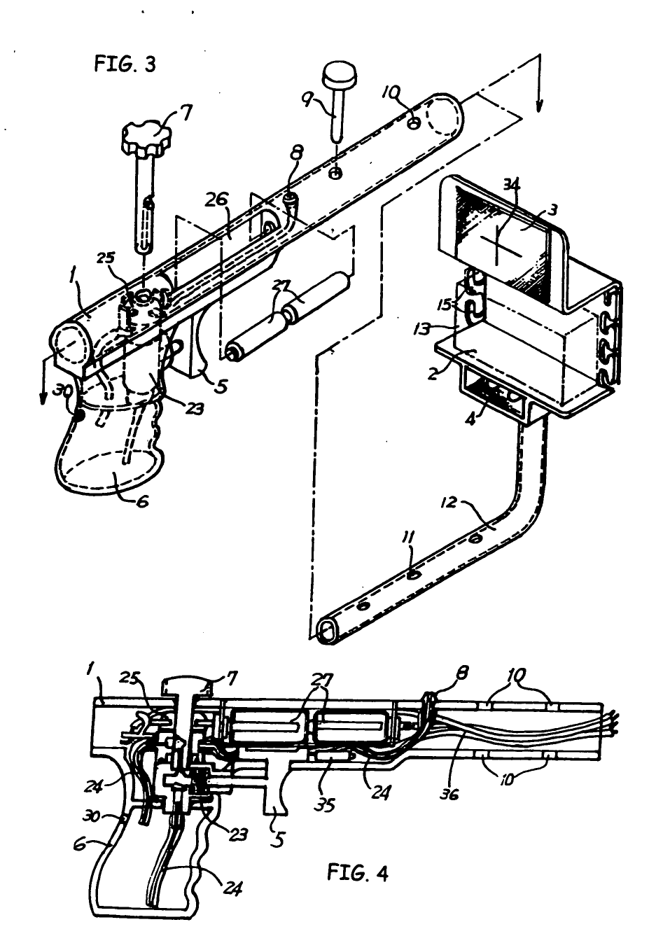

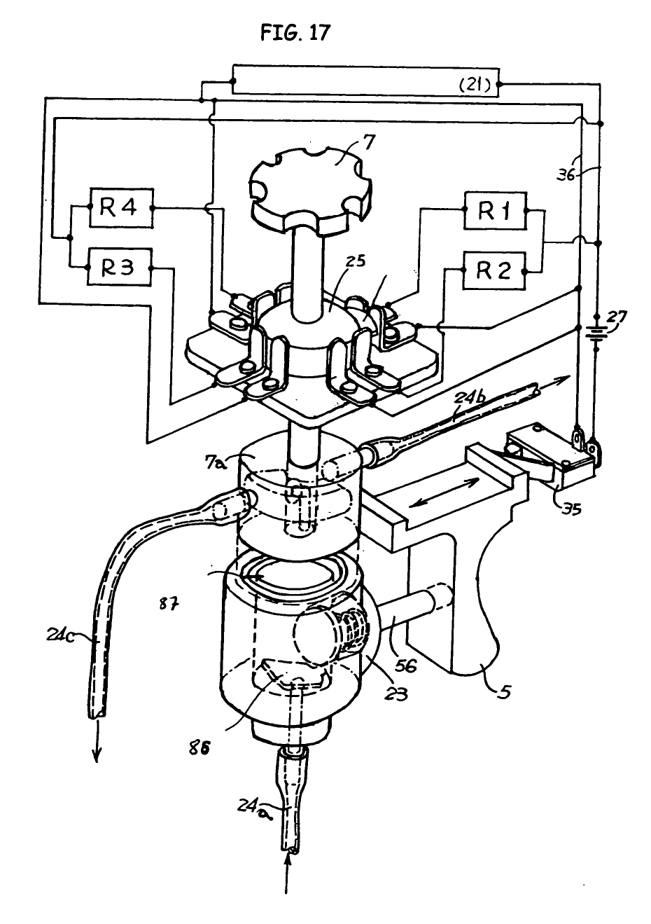

A first embodiment to accomplish this is provided by ball joint type nozzle 8 which can direct a spray of water from a reservoir held in grip 6. In operation, water contained within grip 6 is fed through flexible water suction tube 24a through the actuation of trigger 5 on piston trigger 56. Piston trigger 56 causes valve 85 to allow water stored in grip 6 to enter holding chamber 87. Trigger 56 also causes water in chamber 87 to be pushed upward into firing chamber 7a and through water outlet tube 24b. Water not expelled through tube 24b is returned to grip 6 via water return tube 24c. This mechanism is best shown in FIGS. 3, 4, and 17 noting that the trigger actuation through its stem actuates pump system 23 much like an ordinary toy water gun.

Trigger 5 can also be employed to actuate shutter 32 contained within camera 13 so that a water spray can initially be employed to startle a subject whereupon further trigger actuation trips camera shutter 32 capturing the startled user. Shutter actuation is carried out through the use of micro switch 35 (FIG. 4). Water can be introduced to grip 6 through filler hole 30. In another embodiment, shutter actuation is carried out through the use of a mechanical device discussed later in the application.

Turning next to FIGS. 2-1 to 2-4, camera holder 2 is shown with some degree of detail. Specifically, camera holder 2 is attached to extension arm 12 by a slip joint having an oblong lock pinhole 38 which accepts lock pin 37 and allows for a horizontal offset. Mirror 3 can be made with a convex surface to allow increased widths similar to that gained with a convex lens. Camera holder 2 can be provided with L hooks 15 and, T hooks 16 for engaging rubber band 14 to maintain camera 13 in position. Camera button slit 19 receives solenoid plunger 21 held in position by locking nuts 28 thus positioning plunger top 22 appropriately. This can be used to actuate various devices used to attract subjects whose pictures are being taken.

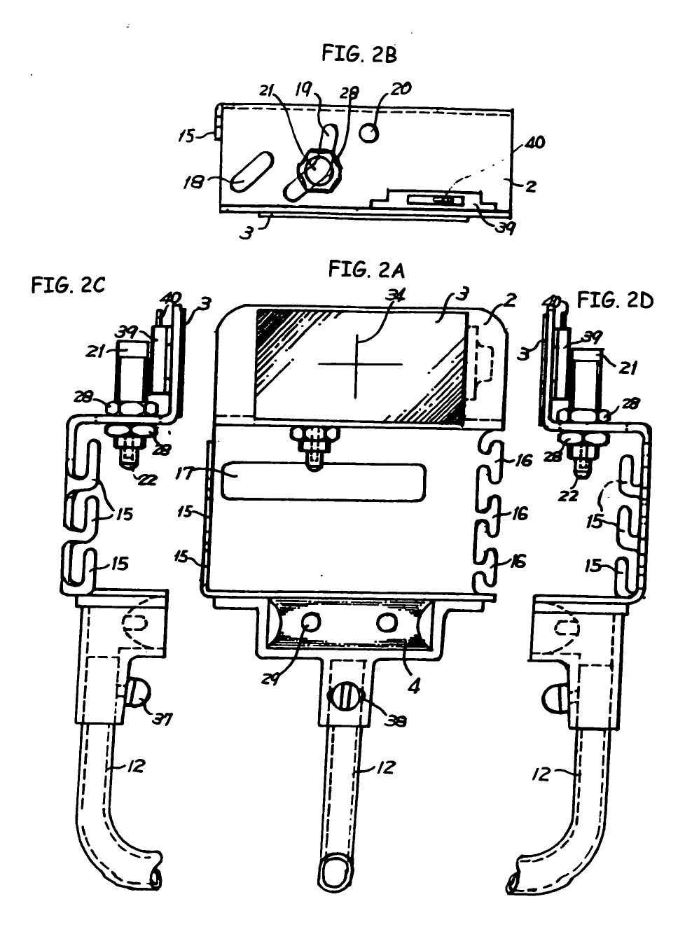

As shown in FIG. 2-2, camera 13 can be maintained on camera holder 2 by engaging a suitable threaded receiver within the camera (not shown) with bolt 28 enabling a repositioning of the camera through movement within receiving channel 19. FIG. 2-2 further shows slot 18 for receiving a plunger or suitable actuator for tripping shutter 32 of camera 13 as well as fixture 39 including vibration pin 40 for receiving a suitable sound and motion device described hereinafter. FIG. 2-2 further shows a picture count view window 20 within holder 2 to allow the photographer to keep track of the number of pictures taken on a specific roll of film.

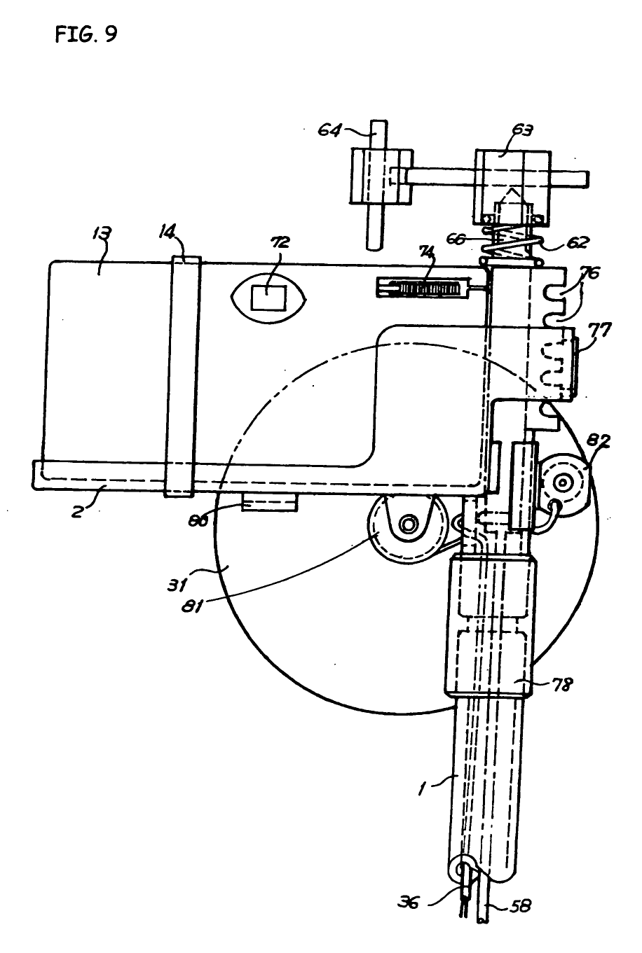

FIG. 2-1 shows a rear view of camera 13 positioned upon holder 2. Although not part of the present invention, film winding wheel 17 is depicted which generally appears on cameras of the type used herein. L hooks 15 and T hooks 16 are employed for maintaining securing elastic bands 14 in position. The height of camera holder 2 and thus the height of camera 13 and mirror 3 is adjustable through the use of camera housing lock pin hole 38 enabling sliding motion to take place over extension arm 1 by tightening and loosening camera housing lock pin 37. In another embodiment (FIG. 9), the height of camera holder 2 and thus the heights of camera 13 and mirror 3 are adjustable through the use height adjustable male teeth 77. Teeth 77 fit in female receptacles 76 enabling a vertical locking mechanism at the desired height. Yet in another embodiment, holder 2, camera 13, and mirror 3 can be rotated clockwise or counterclockwise 180 degrees about a rotatable coupling 78 through the use of a pulley 81 and magnetic motor 82. Light housing 4 is also provided which includes LED 29, the functions of which are described hereinafter.

Turning again to FIGS. 3 and 4, the device of the present invention is shown in phantom thus further illustrating the internal components of a preferred embodiment of the present invention. Specifically, handle 6 is in the form of a pistol grip. Extension arm 12 includes locking pin holes 10 and 11 that align with one another whereupon locking pin 9 is inserted to adjust the length of extension of arm 12 as needed. This device also provides for the inclusion of batteries 27 within battery holder 26 in order to operate various electrically actuated functions of the present invention. As previously noted, water nozzle 8 can be employed drawing water from a reservoir contained within grip 6 while selector dial 7 enables a user to select one of several finctions in practicing the present invention. Selector dial 7 can be rotated to selectively engage dial contacts 25. For example, when properly selected, a fluid path can be completed between the reservoir contained within grip 6 and water nozzle 8. However, when rotated, this function can be disengaged thus preventing water from traveling through flexible tube 24 to water nozzle 8.

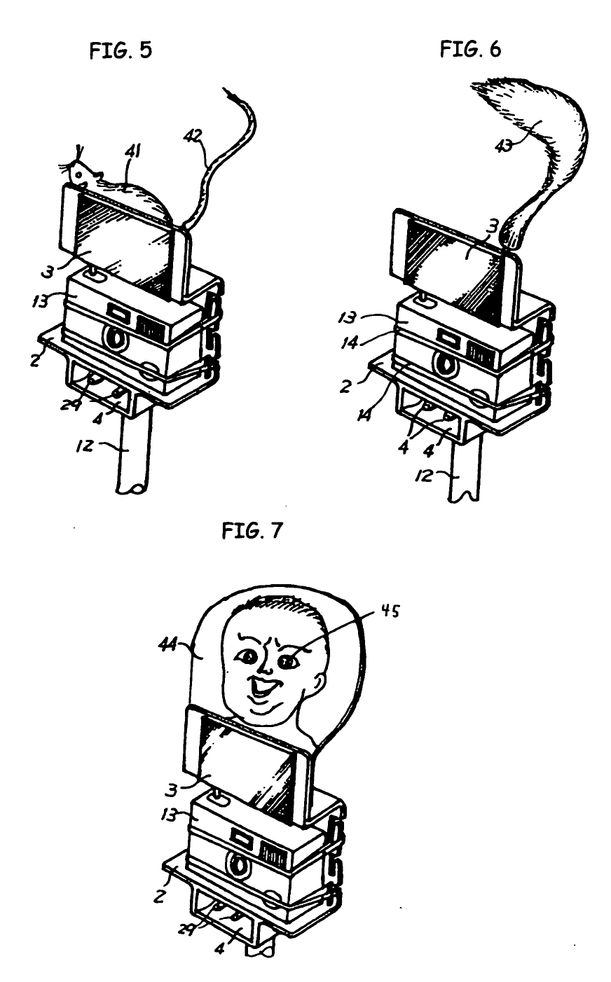

Batteries 27 can be included within battery housing 26. These batteries provide power through micro switch 35 engaged by trigger 5. So engaged, electrical current can be caused to pass through control wires 36 thus providing the necessary power to run functions selected by dial 7. Various positions of dial 7 cause contact 25 to perform various fuinctions as described below. For example, at one position, contact 25 engages control circuitry R1 and R2, responsible for solenoid plunger 21 and fixture 39. At another position, contact 25 engages circuitry R3 responsible for LED 29 and sound playback from ROM. At yet another position, contact 25 engages circuitry R4 responsible for magnetic motor 82 to actuate preferred features generally located on or about camera holder 2. In this regard, reference is made to FIGS. 5, 6, and 7.

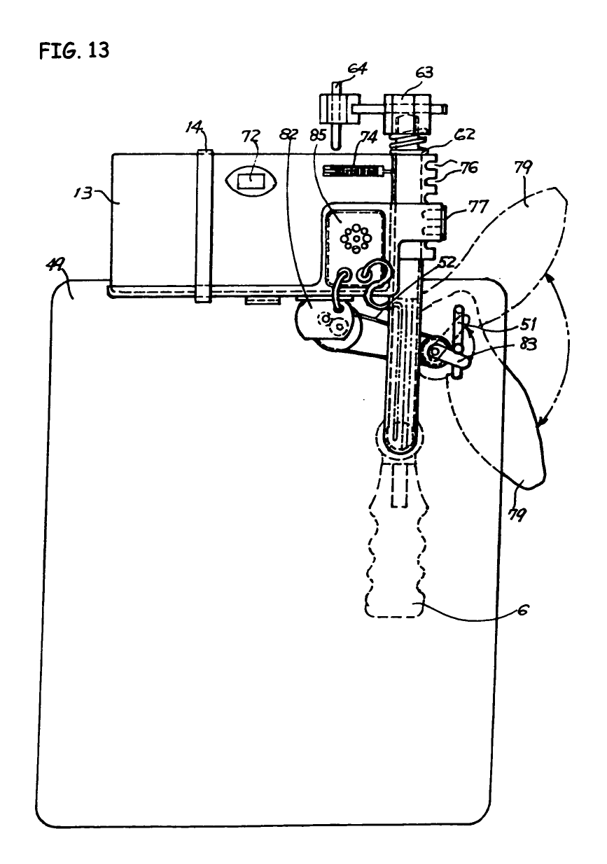

As previously noted, when taking self portraits, particularly those involving infants and small children, it is oftentimes advantageous to provide a means of startling or attracting the young child in order to achieve a more sought after photograph. This can be done a number of ways by, for example, providing an animal such as rat 41 having rat tail 42 composed of, for example, rubber. Rat tail 42 can be actuated with a small electric motor (not-shown) by engaging trigger 5 or any other actuation means thus feeding an electrical current through control wires 36 emanating from batteries 27 and micro switch 35. A similar effect can be achieved in providing animal tail 43 or butterfly 46 (FIG. 1) supported on a wand and again actuated in the same fashion as was the case with rat tail 42. A similar effect can also be achieved in providing an animal appendage such as dog's ear 79 (FIG. 13). Ear 79 can also actuated in the same fashion as described above causing ear 79 to move and wave to gain the attention of a young child. Ear movement can be accomplished by way of a pulley system comprised of crank actuator 83, pulley 81, pulley belt 52 and shaft 51 (FIG. 9). Animal sounds can also be played by way of a recorded voice player 85 by providing a sound generator powered by the same means used to actuate the other attraction means described above.

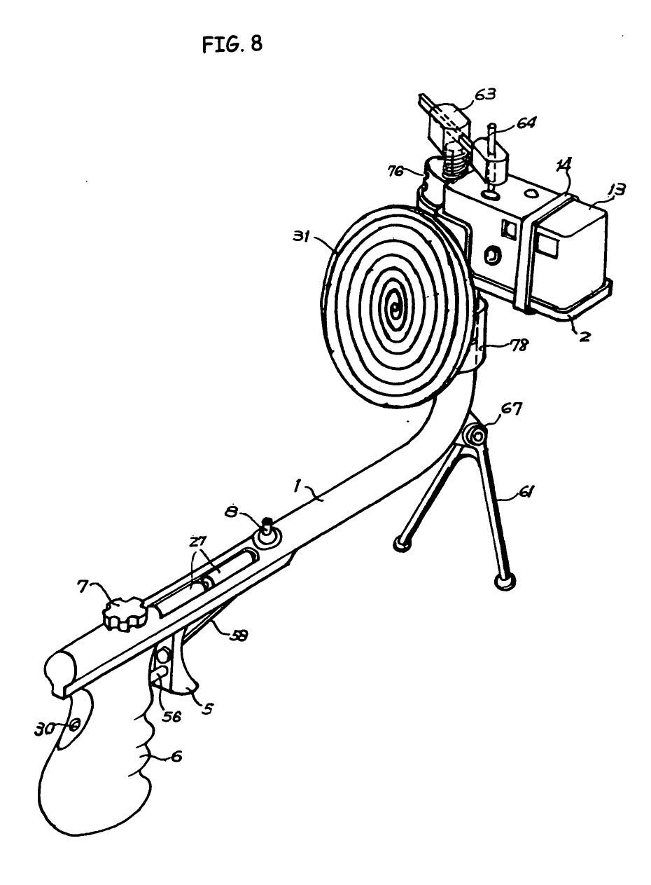

With regards to FIG. 7, the image of a baby 44 or young child can be provided having eyeballs 45 which can be caused to move through the use of a small electric motor located behind image placard 44. In another embodiment, means of startling or attracting a young child in order to achieve a more sought after photograph can be accomplished by using a graphic design 31 (FIG. 8). Graphic design 31 can also actuated in the same fashion as described above in order to effect a mesmerizing spinning movement to gain the attention of a young child.

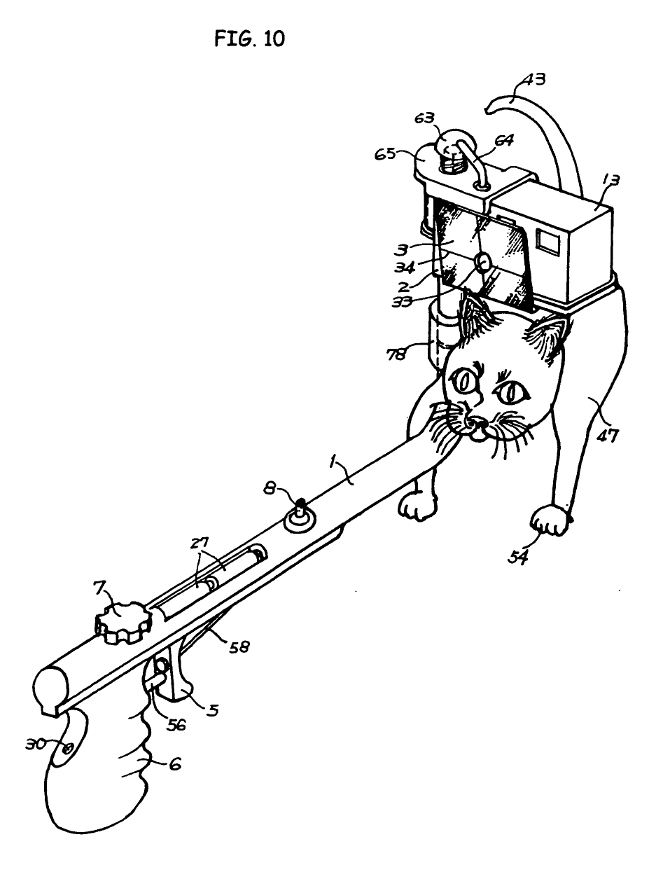

In another embodiment, means of startling or attracting a young child in order to achieve a more sought after photograph can be accomplished by using graphic design 31 (FIG. 8). Graphic design 31 can also be actuated in the same fashion as described above in order to effect a mesmerizing spinning movement to gain the attention of a young child. A further means of startling or attracting a young child can be accomplished by using a 3-D animal figure 47 such as a cat, dog, or other animal (FIG. 10). Animal figure 47 can have realistic features including appendages 54 to evoke a more realistic response from the young child. Animal figure 47 can be made of rubber, cloth, plastic or other similar material and supported by a hook (not shown) fitted into slot 80 underneath camera holder 80. Animal figure 47 can also be actuated in a manner as discussed above.

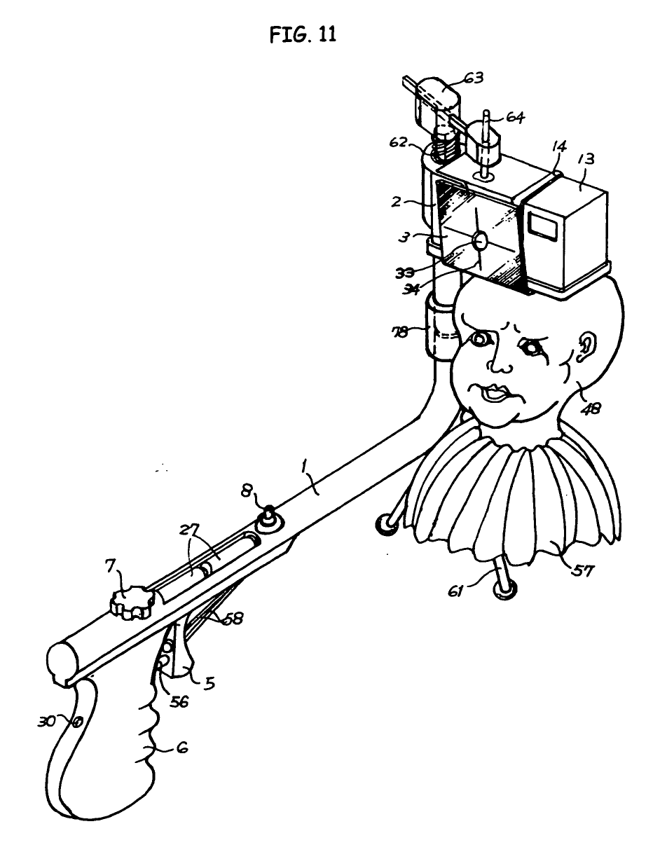

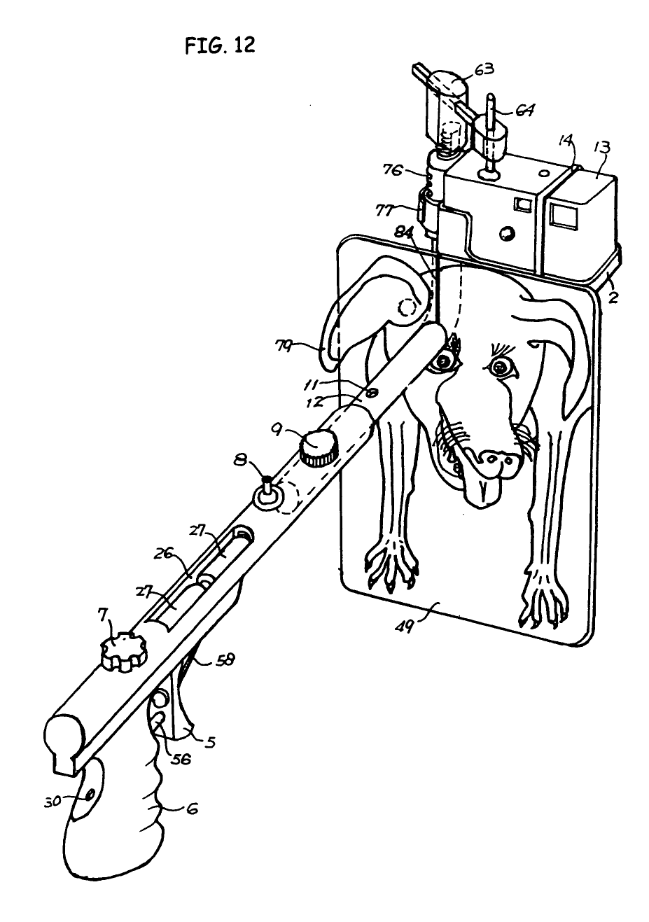

A still further means of startling or attracting a young child can be accomplished by using a 3-D baby figure 48 or other similar doll (FIG. 11). Baby figure 48 can be composed of rubber, cloth, plastic or other similar material and supported by a hook (not shown) fitted into slot 80 of underneath camera holder 80. Baby figure 47 can also be actuated to laugh, cry, make noises or move its eyeballs in a manner as discussed above. Baby figure 47 can also be dressed in a realistic manner including a colorful frill collar 57 in order to further gain the attention of a small child.

A still further means of startling or attracting a young child can be accomplished by using a flat picture panel of an animal such as a dog 49 (FIG. 12). Figure 49 can be composed of paper, cardboard, plastic or other similar flexible material. Figure 49 is placed over extension arm 1 through insert slit 84. Figure 47 can also be actuated to bark, growl, yelp, and make noises in a manner as discussed above.

It should be noted that many features of modern cameras could be incorporated herein. For example, LEDs 29 housed within light housing 4 can be employed to indicate the status of the camera and various attractant mechanisms located in conjunction thereto. In another example, top holder 65 can provide an opening for film winder dial 75 to allow a roll of film to be manually wound. Furthermore, top holder 65 and holder 2 enhance the line of view of various other features of modem cameras, including flash button 53, flash light 71, view window 72, film count window 73,.

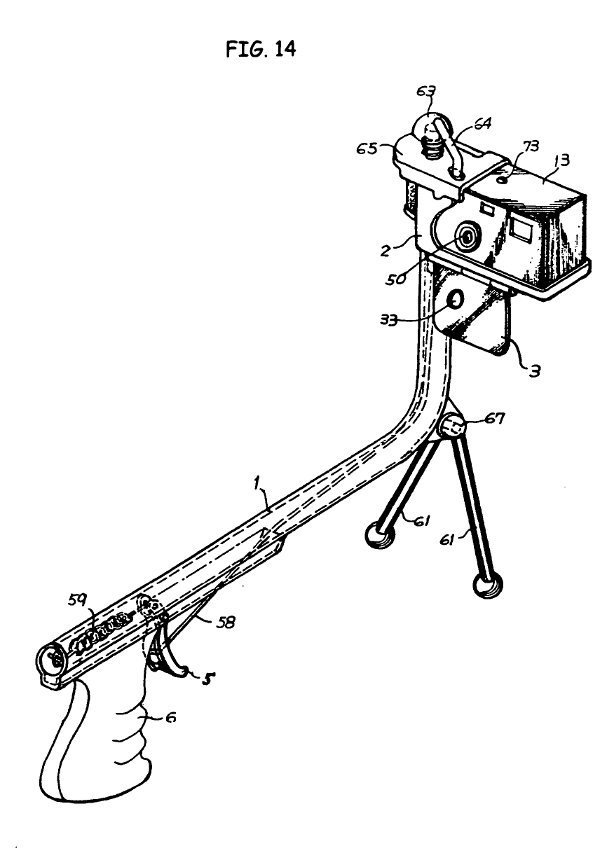

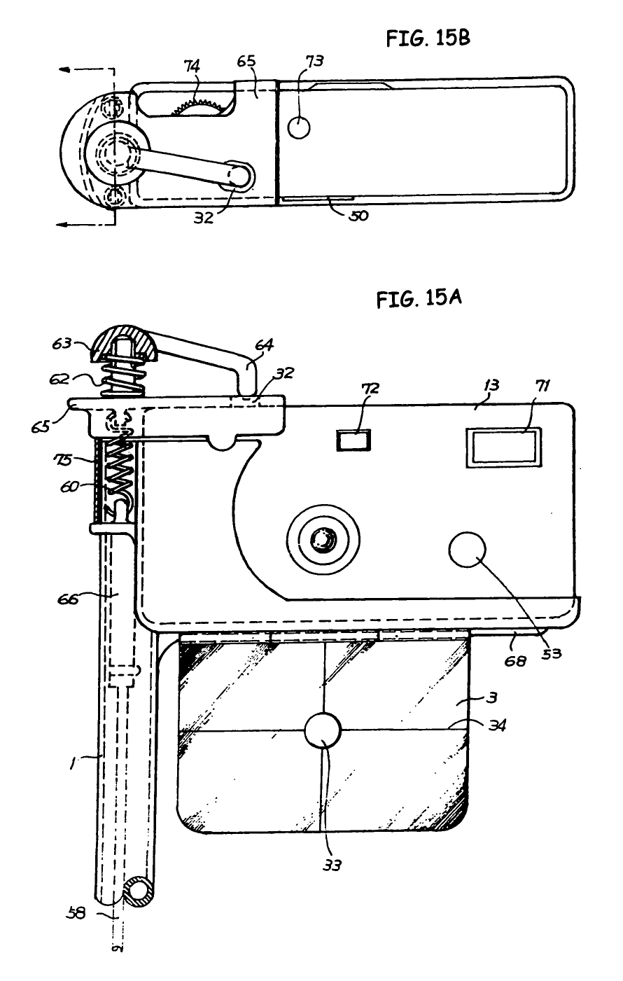

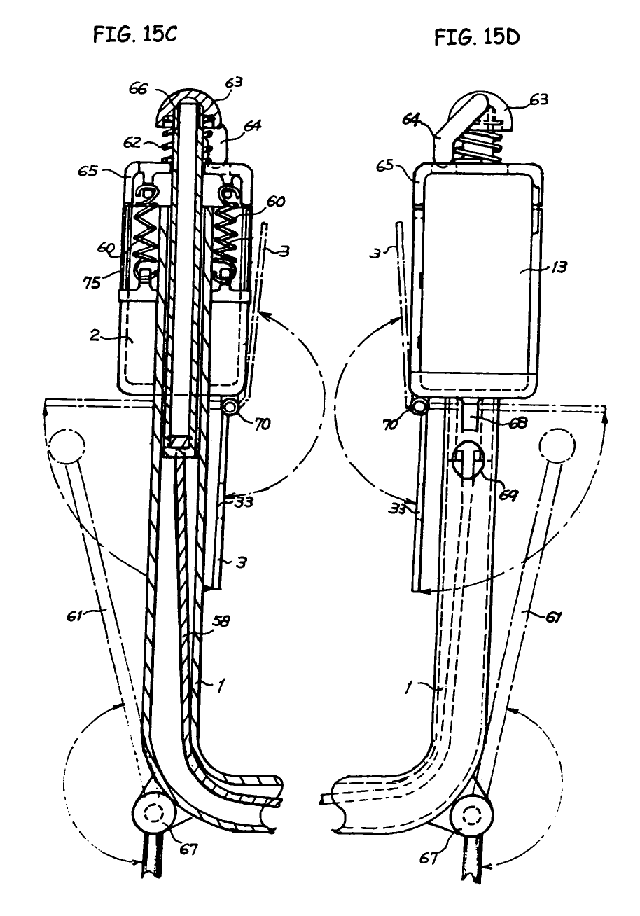

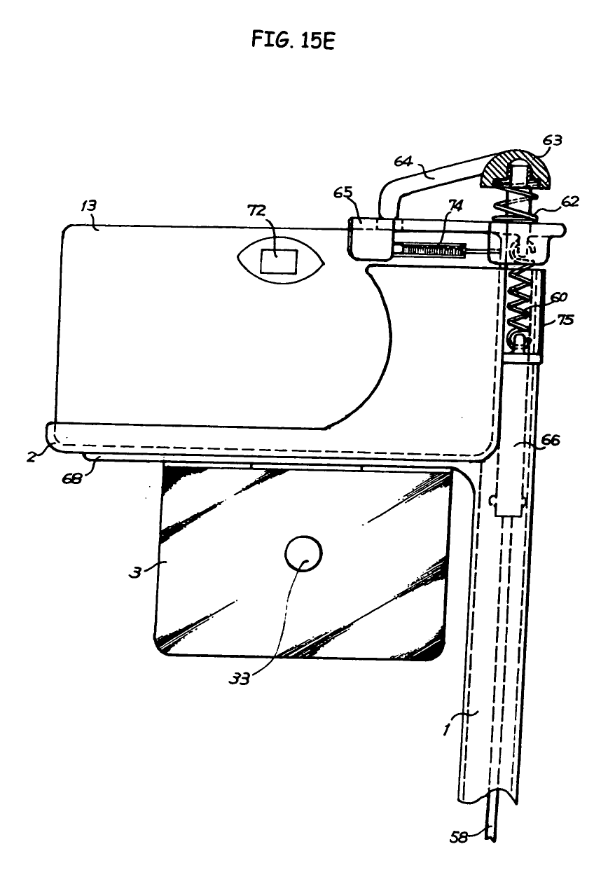

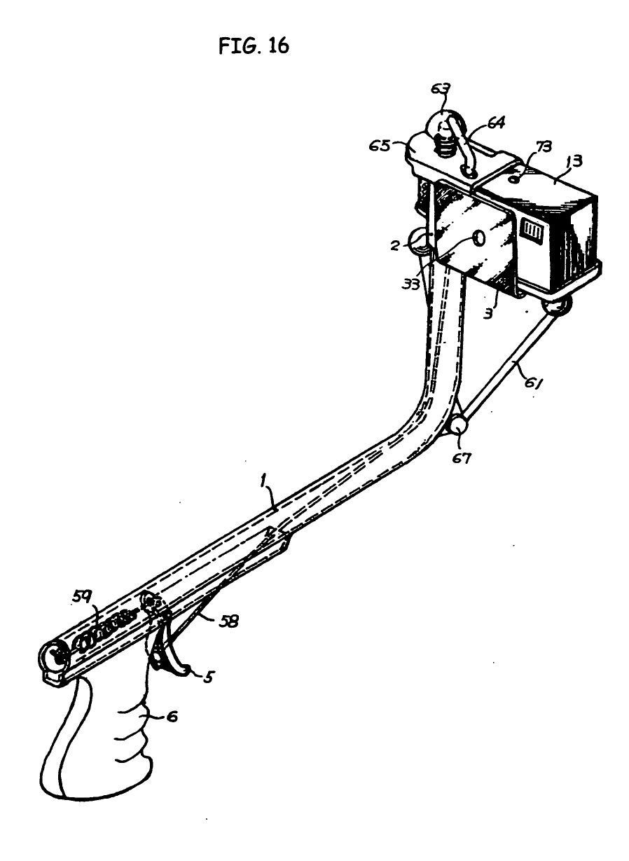

In FIGS. 14, 15, 15A-D and 16, the device of the present invention is shown in phantom illustrating the internal components of another embodiment of the present invention. These internal components may be encased within extension arm 1. Specifically, trigger 5 can be employed to actuate shutter 32 of camera 13. Trigger tension springs 59, camera vice spring 60, and shutter spring 62 provide trigger tension to Trigger 15. Trigger 15 is connected to actuating member 58. Member 58 is connected to cylindrical member 66. Member 66 is coupled to vice spring 60 encased within spring cover 75. Vice spring 60 is coupled to shutter spring 62. Shutter spring 62 is coupled to actuating pin 64 within housing 63. Actuating pin 63 touches shutter 32 of camera 13. To ensure proper operation of trigger 15, viewing hole 69 within extension arm 1 is used to confirm that actuating member 58 is indeed connected to cylindrical member 66. FIG. 2-2 further shows picture count view window 20 for viewing the number of pictures taken on a specific roll of film.

The present invention also permits more stable photography with the use of tripod legs 61 coupled to extension arm 1 at adjustable hinge 67 as shown in FIGS. 8, 11, and 14.

While the present invention has been described in terms of a preferred embodiment above, those skilled in the art will readily appreciate that numerous modifications, substitutions and additions may be made to the disclosed embodiment without departing from the spirit and scope of the present invention. For example, although the camera extension device has been described above for use with a certain startling appendages, those skilled in the art will readily appreciate that the device may be utilized in any similar startling device and that the present invention is in no way limited to mechanisms described above. It is intended that all such modifications, substitutions and additions fall within the scope of the present invention that is best defined by the claims below.

1. A device for facilitating the taking of photographic self portraits, said device comprising a handle sized to be held by a single hand of a user, an extension arm appended at its proximal end to said handle and at its distal end to a camera holder, said extension arm configured to position a camera secured to said camera holder sufficiently above said handle to eliminate said handle from a picture taken when using the present device in taking a photographic self portrait, and a camera and a mirror secured to said camera holder, said mirror being sized and positioned with respect to said camera to enable a user to preview an image to be captured by said camera in creating said photographic self portrait.

2. The device of claim 1 wherein said handle is in the form of a pistol grip having a trigger that, upon actuation, trips a shutter on said camera to facilitate the taking of said photographic self portrait.

3. The device of claim 1 wherein the length of said extension arm is adjustable.

4. The device of claim 1 wherein the length of said extension arm is fixed.

5. The device of claim 2 wherein means are provided for attracting the attention of a user in conjunction with the taking of said self portrait.

6. The device of claim 5 wherein said means for attracting the attention of a user comprises a water spray.

7. The device of claim 6 wherein said water spray emanates from a nozzle located on said extension arm.

8. The device of claim 6 wherein said water spray is actuated from said trigger and water for developing said water spray is held in reservoir housed within said pistol grip.

9. The device of claim 5 wherein said means for attracting a user comprises an audible signal.

10. The device of claim 9 wherein said audible signal comprises replication of a human voice.

11. The device of claim 9 wherein said audible signal comprises replication of animal sounds.

12. The device of claim 5 wherein said means for attracting a user comprises a replica of an animal tail.

13. The device of claim 5 wherein said means for attracting a user comprises a replica of an animal ear.

14. The device of claim 5 wherein said means for attracting a user comprises a replica of a human eye.

15. The device of claim 5 wherein said means for attracting a user comprises a replica of a spiral graphic.

16. The device of claim 1 wherein said mirror has a hole for allowing a camera lens to have a clear line of vision.

17. The device of claim 1 wherein the height of the camera is adjustable.

18. The device of claim 1 further comprising a rotatable coupling allowing said camera to be rotated on a vertical axis 0 to 180 degrees.

19. A device for facilitating the taking of photographic self portraits, said device comprising an extension arm supporting a camera holder and sized to be held by a single hand of a user, said extension arm configured to position a camera secured to said camera holder sufficiently above said extension arm to eliminate said extension arm from a picture taken when using the present device in taking a photographic self portrait, and a camera and mirror secured to said camera holder, said mirror being sized and positioned with respect to said camera to enable a user to preview an image to be captured by said camera in creating said photographic self portrait.
